(19) United States
(12) Patent Application Publication
(10) Pub. No.: US 2020/0087953 A1
(43) Pub. Date: Mar. 19, 2020

(54) DOOR LOCK APPARATUS FOR VEHICLE

(71) Applicant: AISIN SEIKI KABUSHIKI KAISHA, Kariya-shi (JP)

(72) Inventors: Yoshiki ODAKA, Obu-shi (JP); Masanari IWATA, Takahama-shi (JP); Kyoji HIRONO, Nishio-shi (JP); Atsushi YAMAGUCHI, Anjo-shi (JP)

(73) Assignee: AISIN SEIKI KABUSHIKI KAISHA, Kariya-shi (JP)

(21) Appl. No.: 16/552,385

(22) Filed: Aug. 27, 2019

(30) Foreign Application Priority Data
Sep. 18, 2018 (JP) 2018-173499

(51) Int. Cl. E05B 81/56; E05B 79/02

(52) U.S. Cl. CPC E05B 81/56; E05B 81/06; E05B 79/02

(57) ABSTRACT

A door lock apparatus for vehicle includes a first electric circuit, a second electric circuit, and a positioning member. The first electric circuit includes first electric conductive plates formed with terminals connected to an electrical component. The first electric circuit also includes a first support member extending over terminals of the first electric conductive plates, the first support member supporting terminals of the first electric conductive plates. The second electric circuit includes second electric conductive plates formed with terminals connected to an electrical component. The second electric circuit also includes a second support member extending over terminals of the second electric conductive plates, the second support member supporting terminals of the second electric conductive plates. The positioning member determines positions of the first support member and the second support member, and is commonly used for the first support member and the second support member.

### CROSS REFERENCE TO RELATED APPLICATIONS

This application is based on and claims priority under 35 U.S.C. § 119 to Japanese Patent Application 2018-173499, filed on Sep. 18, 2018, the entire content of which is incorporated herein by reference.

### TECHNICAL FIELD

This disclosure generally relates to a door lock apparatus for vehicle. More particularly, this disclosure relates to a door lock apparatus for vehicle including an electric circuit apparatus for detecting an opening or closing state, a locking or unlocking state of a door of the vehicle, and the like.

### BACKGROUND DISCUSSION

Generally, a door lock apparatus for vehicle includes a latch, a pole, a lift lever, an open link, an active lever, and the like. Further, the door lock apparatus for vehicle includes an electric circuit apparatus including a detection apparatus configured to detect an opening or closing state of a door for vehicle by detecting a pivoting angle, a position, and the like of those components, and a drive apparatus configured to switch a locking or unlocking state of the door for vehicle, and the like.

For example, a door lock apparatus for vehicle according to JP2017-95954A (Reference 1) includes an electric circuit apparatus as a detection apparatus configured to detect an opening or closing state of the door for vehicle. This electric circuit apparatus includes a microswitch. Further, the door lock apparatus for vehicle includes a switch lever configured to swing in association with swing of the latch. When a swinging position of the latch is in an unlatched position, the switch lever spaces apart from an actuator (traveling contact) of the microswitch (hereinafter, the switch is referred to as a courtesy switch). In other words, the courtesy switch is set to the OFF state. On the other hand, when the swinging position of the latch is in a latched position, the actuator of the courtesy switch is pressed by the switch lever. In other words, the courtesy switch is set to the ON state.

A door lock apparatus for vehicle according to JP2011-84952A (Reference 2) includes an electric circuit apparatus as a detection apparatus configured to detect a locking or unlocking state of a door for vehicle. The electric circuit apparatus also includes a microswitch. When an active lever is in an unlocking position, a switch lever spaces apart from an actuator (traveling contact) of a position switch. In other words, the microswitch (hereinafter, the switch is referred to as a position switch) is set to the OFF state. On the other hand, when a swinging position of the active lever is in a locking position, the actuator of the position switch is pressed by the active lever. In other words, the position switch is set to the ON state.

Further, a door lock apparatus for vehicle according to JP5955516B (Reference 3) includes an electric circuit apparatus as a detection apparatus configured to detect a rotating position of a key (or a key cylinder) for locking or unlocking a door for vehicle from an outside of a compartment of the vehicle.

A terminal (fixed contact) of the microswitch is connected to a switch terminal (an electric conductive plate) constituted of an elongated metal plate. Specifically, one end of each switch terminal and the other end are provided with a pin. The microswitch is provided with a through hole, and the pin of the one end of the switch terminal is inserted into the through hole. Thereby, the fixed contact is connected to the pin electrically. Further, a housing of the microswitch is locked to a housing of the door lock apparatus for vehicle. Thereby, the microswitch is fixed to the housing. The one end of the switch terminal is fixed to the housing through the microswitch.

Each door lock apparatus for vehicle according to References 1 to 3 includes an electric motor configured to drive an active lever. Both terminals (power source terminals) of the electric motor are connected to a pin of one end of a motor terminal similar to the above-described switch terminal.

Further, a pin of the other end of each switch terminal and each motor terminal is accommodated by each accommodating portion with which one connector housing is provided. An control apparatus (ECU) is connected to the connector housing through a cable (wire harness).

The electric circuit apparatus as described above is installed in a housing accommodating components of a door lock apparatus for vehicle as follows. At first each switch terminal and each motor terminal are placed on a predetermined portion in the housing. Then, a microswitch and an electric motor are connected to a pin of one end of each terminal. Finally, a connector housing (pin header base) is installed to a pin of the other end of each terminal.

It is hard to install a connector housing to a pin of the other end of each terminal when a position of each terminal placed on a housing is misaligned from a regular position, and there is a possibility that a pin is bent, a pin is broken, and the like, in the installing work. Therefore, it is necessary to accurately place each terminal on a regular position, and this brings low productivity of the door lock apparatus for vehicle.

A need thus exists for a door lock apparatus for vehicle which is not susceptible to the drawback mentioned above.

### SUMMARY

A door lock apparatus for vehicle includes a first electric circuit, a second electric circuit, and a positioning member. The first electric circuit includes a plurality of first electric conductive plates, each being an elongated electric conductive plate and formed with terminals connected to an electrical component. The first electric circuit also includes a first support member extending over the terminals of the plurality of first electric conductive plates, the first support member supporting the terminals of the plurality of first electric conductive plates. The second electric circuit includes a plurality of second electric conductive plates, each being an elongated electric conductive plate and formed with terminals connected to an electrical component. The second electric circuit also includes a second support member extending over the terminals of the plurality of second electric conductive plates, the second support member supporting the terminals of the plurality of second electric conductive plates. The positioning member is configured to determine positions of the first support member and the second support member, and is commonly used for the first support member and the second support member.

In the door lock apparatus for vehicle according to an aspect of this disclosure, positions of a first support member and a second support member are determined by the same positioning member. Therefore, a positional relationship (relative position) of the first support member and the second support member is hard to be misaligned. As described above, according to this disclosure, only by engaging the first support member and the second support member with the positioning member, the positional relationship of the first support member and the second support member can be set to a regular state. Thus, productivity of the door lock apparatus for vehicle can be improved.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a door on a right side of a vehicle where a door lock apparatus for vehicle according to one embodiment of this disclosure is installed when seen from an inside of a compartment;

FIG. 2 is a perspective view of the door lock apparatus for vehicle;

FIG. 3 is a side view of an electric circuit apparatus when seen from the left;

FIG. 4 is an exploded perspective view of the electric circuit apparatus;

FIG. 5 is a perspective view of a switch circuit;

FIG. 6 is a perspective view of a motor circuit; and

FIG. 7 is a sectional view of VII-VII in FIG. 3.

### DETAILED DESCRIPTION

A door lock apparatus for vehicle 1 according to one embodiment of this disclosure will be described below. Note that this embodiment is an example of applying this disclosure to a door lock apparatus of a door on the right side of a vehicle, but this disclosure is also applicable to a door lock apparatus of another door.

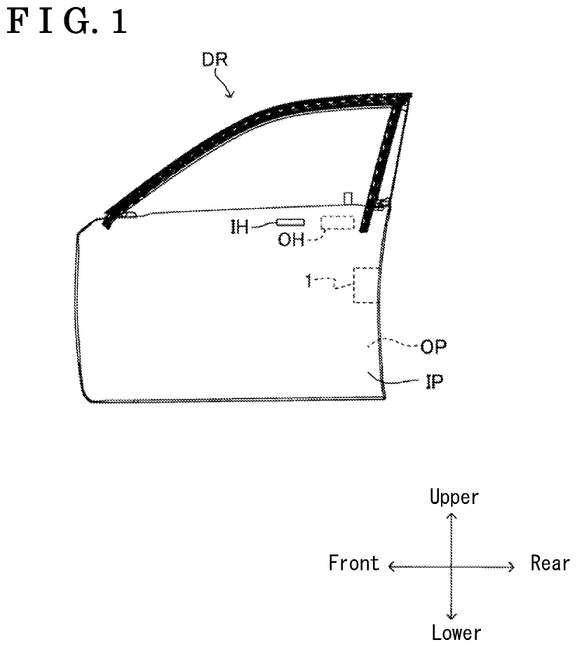

As illustrated in FIG. 1, the door lock apparatus for vehicle 1 is disposed between a door outer panel OP (vehicle outside panel) and a door inner panel IP (vehicle inner panel) of a door for vehicle DR.

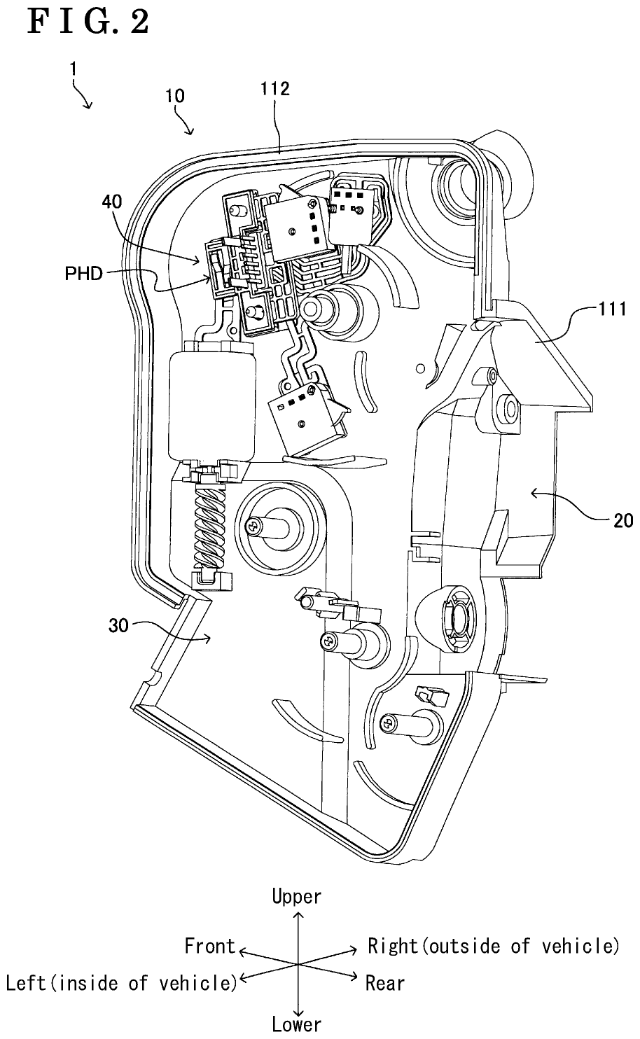

The door lock apparatus for vehicle 1 includes a housing 10, a latch mechanism 20, a lock mechanism 30, and an electric circuit apparatus 40 as illustrated in FIG. 2. Note that, in FIG. 2, components of the latch mechanism 20 and the lock mechanism 30 are omitted from illustration.

The housing 10 is a box-shaped member accommodating the latch mechanism 20, the lock mechanism 30, and the electric circuit apparatus 40. The housing 10 is made of synthetic resin.

The housing 10 includes a rear wall portion 111 which is perpendicular to a vehicle front-rear direction and a side wall portion 112 which is perpendicular to a vehicle width direction. A left edge portion of the rear wall portion 111 and a rear end portion of the side wall portion 112 are connected.

The latch mechanism 20 maintains the door for vehicle DR in a close down state by engagement with a striker attached to a circumferential portion of an entrance of a vehicle body. The latch mechanism 20 includes a latch, a pole, and the like similar to those of a known door lock apparatus for vehicle.

The latch is a substantially disc-shaped member supported rotatably around a shaft member provided on the rear wall portion 111. The latch includes a notch portion which extends from an outer peripheral surface of the latch to the inside. The latch is in a state where the door for vehicle DR can be opened when the swinging position of the latch is in a unlatched position. When the door for vehicle DR is closed in this state, the latch receives the striker in the notch portion and swings in a predetermined direction. Then, the pole engages the latch, and the door for vehicle DR is maintained in a closed state. In other words, the pole maintains a swinging position of the latch in a latched position (a state where the door for vehicle cannot be opened). The pole is connected to an inside door handle IH provided on a compartment inside surface of the door for vehicle DR and an outside door handle OH provided on a compartment outside surface of the door for vehicle (see FIG. 1) through a lift lever and an open link not illustrated. When the inside door handle IH or the outside door handle OH is pulled, the pole swings through the open link and the lift lever, and the engagement with the latch is released. Thereby, the swinging position of the latch returns to the unlatched position.

The lock mechanism 30 switches the unlock state where the engagement of the latch mechanism 20 and the striker can be released, and the lock state where the engagement of the latch mechanism 20 and the striker cannot be released. This lock mechanism 30 includes an active lever and the like.

The active lever is supported rotatably around a shaft member provided on the side wall portion 112. The active lever is connected to an operator for locking and unlocking (e.g., a door lock knob and a key cylinder) and is connected to the open rink. When the operator for locking and unlocking is set to an unlocking state, a swinging position of the active lever is in a predetermined unlocking position. In this state, the engagement of the open link and the lift lever is released, and an operation of the inside door handle IH and the outside door handle OH is conveyed to the pole. On the other hand, when the operator for locking and unlocking is set to a locking state, the active lever swings in a predetermined direction and moves the open link, and then the engagement of the open link and the lift lever is released. Therefore, an operation of the inside door handle IH and the outside door handle OH is not conveyed to the pole.

For further specific configurations of the latch mechanism 20 and lock mechanism 30 described above, refer to, for example, the “latch unit” and “actuator unit”, and the like disclosed in JP2017-95954A.

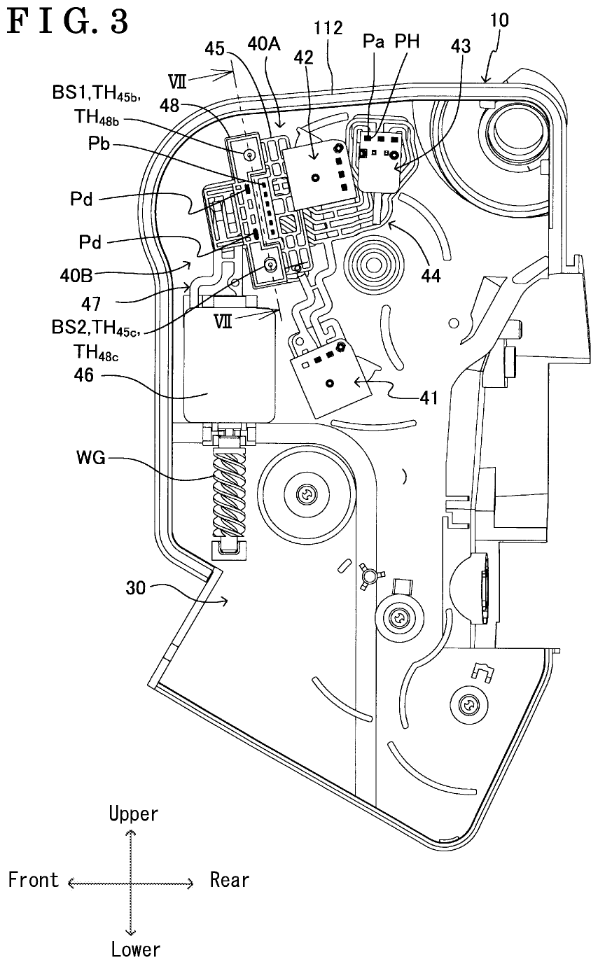

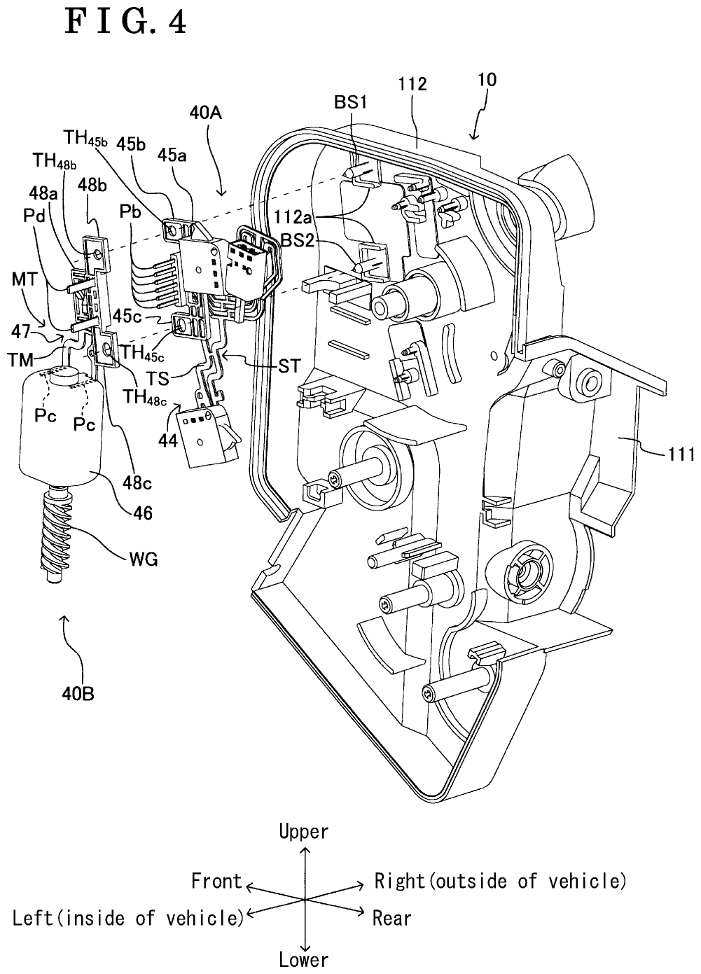

Next, the electric circuit apparatus 40 will be described. As illustrated in FIGS. 3 and 4, the electric circuit apparatus 40 includes a switch circuit 40A and a motor circuit 40B. The switch circuit 40A corresponds to the first electric circuit of this disclosure, and the motor circuit 40B corresponds to the second electric circuit of this disclosure.

The switch circuit 40A detects a swinging position of a member to swing (e.g., the latch, the active lever, the key cylinder, and the like), among components of the door lock apparatus for vehicle 1. The motor circuit 40B swings a member to swing (e.g., the active lever), among components of the door lock apparatus for vehicle 1.

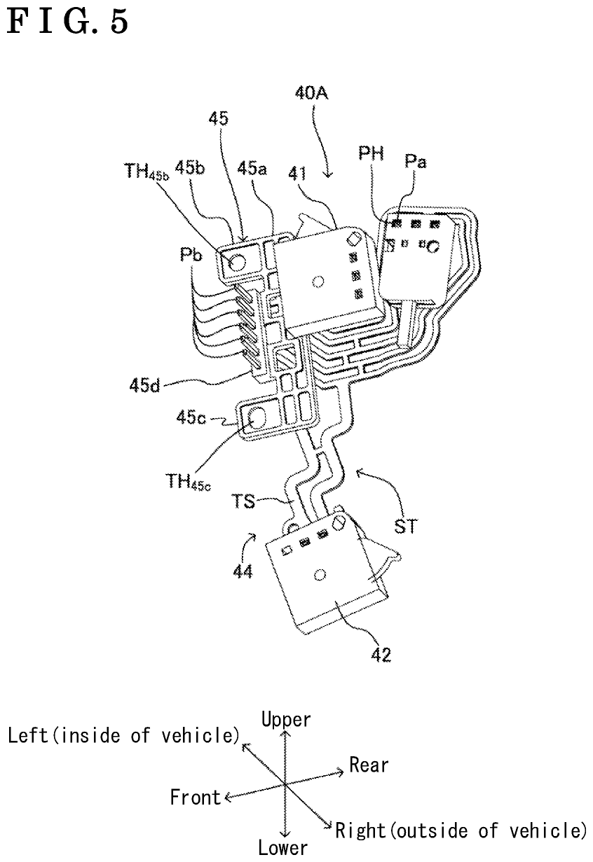

The switch circuit 40A includes a first switch 41, a second switch 42, a third switch 43, a switch terminal 44, and a pin header base 45 as illustrated in FIG. 5. For the first switch 41, the second switch 42, and the third switch 43, a known microswitch is used. In other words, each of the first switch 41, the second switch 42, and the third switch 43 includes a case and an actuator. A plurality of electric contacts are provided in the case. When the actuator is pushed, two electric contact of the plurality of electric contacts come into contact, and the two electric contacts are thus brought into a conduction state (ON state).

Each actuator of the first switch 41, the second switch 42, and the third switch 43 engages, for example, the latch, the active lever, the key cylinder, and the like. ON/OFF states of the first switch 41, the second switch 42, and the third switch 43 change depending on swinging positions of the members engaged therewith.

A pin insertion hole PH is formed to each case of the first switch 41, the second switch 42, and the third switch 43. A pin Pa described below is inserted into the pin insertion hole PH, and an electric contact (fixed contact) of each switch contacts the pin Pa, and the pin Pa and the electric contact are thus brought into a conduction state.

The switch terminal 44 is a conductive line that is connected to the first switch 41, the second switch 42, and the third switch 43, is conductive to the electric contact of each switch, and transmits electrical signals. In this embodiment, the switch terminal 44 is configured with six terminals TS. Each terminal TS is made of an elongated metal plate. Each terminal TS is appropriately bent at an intermediate portion in the extension direction. Pins Pa and Pb are formed on both end portions in the extension direction of each terminal TS, respectively. The pins Pa and Pb are extended in a direction perpendicular to portions except the pins Pa and Pb in each terminal TS. Note that, the terminal TS corresponds to the first electric conductive plate of this disclosure, and the pin Pb corresponds to the terminal of the first electric conductive plate of this disclosure.

The pin Pa on a tip portion side of each terminal TS is inserted into the pin insertion hole PH of each of the first switch 41, the second switch 42, and the third switch 43. The pins Pb on a base end portion side of each terminal TS are arranged in a single row (the vertical direction) at a predetermined interval (e.g., 2.54 mm). A pin header base 45 is formed integrally on a part of the base end portion side of each terminal TS by using an outsert molding method (an insert molding method). Note that the pin header base 45 corresponds to the first support member of this disclosure.

The pin header base 45 is formed in a substantially plate shape. The pin header base 45 is a substantially rectangular plate shape portion extending in an array direction (the vertical direction) of the pins Pb of the base end portion side of each terminal TS constituting the switch terminal 44. A plate thickness direction of the pin header base 45 corresponds to the extension direction of the pin Pb. The pin header base 45 includes a rectangular thin-plate body portion 45a extending in the vertical direction, flange portions 45b and 45c protruding forward from a top end portion and a bottom end portion of a front side edge of the body portion 45a, and a pedestal portion 45d protruding forward from the intermediate portion of the front side edge of the body portion 45a. A plate thickness of the flange portions 45b and 45c is the same as that of the body portion 45a. Through holes TH_{45b} and TH₄₅, are formed on the flange portions 45b and 45c, respectively. The through hole TH_{45b} is a circular hole (reference hole), and the through hole TH_{45c}, is an oblong hole extending in the vertical direction. Further, the pedestal portion 45d is extended in the vertical direction between the flange portion 45b and the flange portion 45c. The pedestal portion 45d keeps and supports a root part of each pin Pb at regular intervals. In other words, each pin Pb passes through the pedestal portion 45d and extends to the left. A plate thickness of the pedestal portion 45d is slightly larger than the plate thickness of the body portion 45a. In other words, a step is formed between the body portion 45a and the pedestal portion 45d. Note that the flange portion 45b (or the flange portion 45c) corresponds to the plate shape portion of this disclosure.

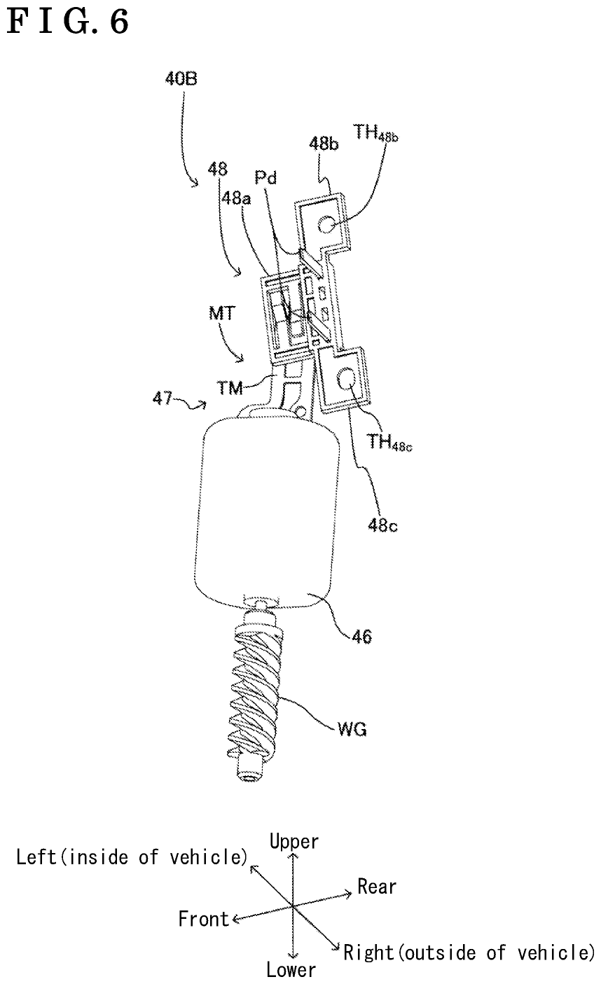

The motor circuit 40B includes an electric motor 46, a motor terminal 47, and a pin header base 48 as illustrated in FIG. 6. As the electric motor 46, a known direct current electric motor is used. Note that, for example, a worm gear WG is installed in an output axis of the electric motor 46. For example, the worm gear WG is engaged with a gear portion provided on the outer peripheral surface of the active lever.

The motor terminal 47 is connected to the electric motor 46 and is a conductive line which supplies power to the electric motor 46. The motor terminal 47 is configured with two terminals TM. Each terminal TM is made of an elongated metal plate. Each terminal TM is appropriately bent at an intermediate portion in the extension direction. Pins Pc and Pd are formed in both end portions in the extension direction of each terminal TM, respectively. The pins Pc and Pd are extended in a direction perpendicular to a part except the pins Pc and the Pd in each terminal TM. Note that the terminal TM corresponds to the second electric conductive plate of this disclosure, and the pin Pd corresponds to the terminal of the second electric conductive plate of this disclosure.

The pin Pc on the tip portion side of each terminal TM is connected to an electrode terminal of the electric motor 46. Further, the pin header base 48 is formed integrally by using the outsert molding method on a part of the base end portion side of each terminal TM where the pins Pd on the base end portion side of each terminal TM are arranged in a single row (the vertical direction) at a predetermined interval (e.g., 12.7 mm). Note that, the pin header base 48 corresponds to the second support member of this disclosure.

The pin header base 48 is formed in a substantially plate shape. The pin header base 48 is a substantially rectangular plate shape portion extending in an array direction (the vertical direction) of the pins Pd on the base end portion side of each terminal TM constituting the motor terminal 47. A plate thickness direction of the pin header base 48 corresponds to the extension direction of the pin Pd. The pin header base 48 includes a rectangular plate shape body portion 48a extending in the vertical direction, a flange portion 48b protruding upward from a rear portion of an upper side edge of the body portion 48a, and a flange portion 48c protruding downward from a rear portion of a bottom side edge of the body portion 48a. The rear edge portion of the body portion 48a supports a root part of each pin Pd. In other words, each pin Pd passes through the rear edge portion of the body portion 48a and extends to the left.

In a lateral view (state when seen from the inside of the compartment) of the pin header base 48, the flange portions 48b and 48c present a substantially square. Each rear edge of the flange portions 48b and 48c is located on a back side farther than the rear edge of the body portion 48a. In other words, the flange portions 48b and 48c project a little more backward than the body portion 48a. A plate thickness of the flange portions 48b and 48c is the same as that of the body portion 48a. Through holes TH_{48b} and TH_{48c} are formed on the flange portions 48b and 48c, respectively. The through hole TH_{48b} is a circular hole (reference hole), and the through hole TH_{48c} is an oblong hole extending in the vertical direction. As specifically described below, the flange portion 48b is overlapped with the flange portion 45b, and the flange portion 48c is overlapped with the flange portion 45c. Thus, in a state where the flange portions 45b and 45c and the flange portions 48b are 48c are overlapped, respectively, it is set that the through hole TH_{45b} and the through hole TH_{48b} are coaxially located and the through hole TH_{45c} and the through hole TH_{48c} are coaxially located. Note that the flange portion 48b (or the flange portion 48c) corresponds to the plate shape portion of this disclosure.

The side wall portion 112 is provided with a columnar (or conically-shaped) boss BS1 corresponding to the through hole TH_{45b} and the through hole TH_{48b} and a columnar (or conically-shaped) boss BS2 corresponding to the through hole TH_{45c} and the through hole TH_{48c}. The boss BS1 is inserted into the through hole TH_{45b} and the through hole TH_{48b}, and the boss BS2 is inserted into the through hole TH_{45c} and the through hole TH_{48c} and fitted therein. Thereby, the pin header base 45 and the pin header base 48 are locked to the side wall portion 112. Note that the boss BS1 (or the boss BS2) corresponds to the positioning member of this disclosure.

The electric circuit apparatus 40 configured as described above is manufactured and installed in the side wall portion 112 as follows. At first a base material configured by a metal plate is processed by die cutting, and a switch terminal plate piece ST and a motor terminal plate piece MT are formed. The switch terminal plate piece ST is a member in a shape where plate piece portions corresponding to respective terminals TS are connected to each other at those intermediate portions. The motor terminal plate piece MT is a member in a shape where plate piece portions corresponding to respective terminals TM are connected to each other at those intermediate portions. Note that parts corresponding to the pins Pa and Pc and the pins Pb and Pd are formed on a tip portion and a base end portion of the switch terminal plate piece ST and the motor terminal plate piece MT, respectively.

Then, a root portion of a part corresponding to each pin Pa and Pb and pin Pc and Pd in the switch terminal plate piece ST and the motor terminal plate piece MT is bent, and the pins Pa and Pb and pins Pc and Pd are processed so as to extend perpendicular to other parts.

Then, the pin header base 45 is formed on a peripheral portion of the pin Pb of the base end portion side of the switch terminal plate piece ST by using the outsert molding method (the insert molding method). Further, the pin header base 48 is formed on a peripheral portion of the pins Pc and Pd of the base end portion side of the motor terminal plate piece MT by using the outsert molding method (the insert molding method).

Then, the first switch 41, the second switch 42, and the third switch 43 are implemented at the pin Pa of each terminal TS of the switch terminal plate piece ST. Further, the electric motor 46 is connected to the pin Pc of the motor terminal plate piece MT.

Then, as illustrated in FIG. 8, the switch terminal plate piece ST is brought close to the side wall portion 112 from the left of the side wall portion 112, and the bosses BS1 and BS2 are inserted into the through holes TH_{45b} and TH_{45c}, respectively. Then, the motor terminal plate piece MT is brought close to the side wall portion 112 from the left of the side wall portion 112, and the bosses BS1 and BS2 are inserted into the through holes TH_{48b} and TH_{48c}, respectively. In other words, the flange portions 48b and 48c are overlapped with the flange portions 45b and 45c, and thereby the switch terminal plate piece ST and the motor terminal plate piece MT are installed in the side wall portion 112 (see FIG. 4).

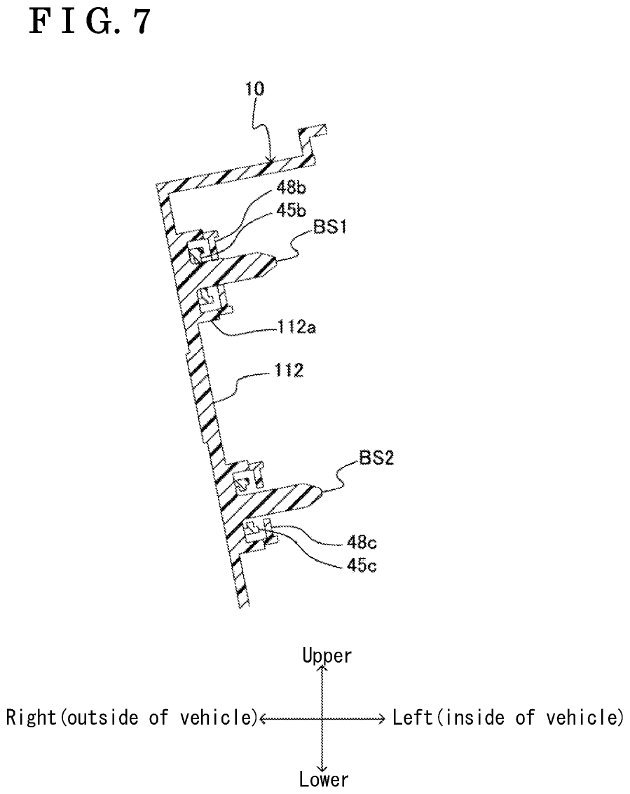

Note that, as illustrated in FIG. 7, the flange portions 45b and 45c abut with a left surface of the side wall portion 112. Further, the side wall portion 112 is provided with a peripheral wall portion 112a that is short in height around edges of the upper side, the front side, and the lower side of the flange portions 45b and 45c (see FIG. 4). The flange portions 48b and 48c abut with an end surface (top surface) of the peripheral wall portion 112a (see FIG. 7).

Finally, a connecting portion connecting intermediate portions of each terminal TS of the switch terminal plate piece ST and a connecting portion connecting intermediate portions of each terminal TM of the motor terminal plate piece MT are cut by a cutting tool.

Note that, one pin header PHD is configured with the pin header base 45, the pin header base 48, and the pins Pb and Pd supported by these pin header bases (see FIG. 2). A control apparatus (ECU) and a power supply circuit are connected to the pin header PHD through a cable (wire harness) not illustrated. With this configuration, ON/OFF states of the first switch 41, the second switch 42, and the third switch 43 are detected by the control apparatus, and power is supplied to the electric motor 46 from the power supply circuit. Note that the pin header PHD corresponds to the connector member of this disclosure.

As described above, in this embodiment, the pin header base 45 is formed on the peripheral portion of the pin Pb of the base end portion of the switch terminal plate piece ST in a state where each terminal TS is connected, by using the outsert molding method (the insert molding method). In other words, the pin header base 45 is formed in a state where there is almost no mismatch in a positional relationship (relative position) between terminals TS and a positional relationship between pins Pb on the base end portion side, and the positional relationship of each of the pins Pb is maintained by this pin header base 45.

The pin header base 48 is formed on the peripheral portion of the pin Pd of the base end portion of the motor terminal plate piece MT in a state where each terminal TM is connected, by using the outsert molding method (the insert molding method). In other words, the pin header base 48 is formed in a state where there is almost no mismatch in a positional relationship (relative position) between terminals TM and a positional relationship between pins Pd on the base end portion side, and the positional relationship of pins Pd is maintained by this pin header base 48.

Then, the pin header base 45 is locked to the bosses BS1 and BS2, and the pin header base 48 is also locked to the bosses BS1 and BS2. In other words, positions of the pin header base 45 and the pin header base 48 are determined by the same positioning portion (specifically, boss BS1). Therefore, the positional relationship (relative position) of the pin header base 45 and the pin header base 48 is hard to be misaligned.

As described above, according to this embodiment, only by the pin header base 45 being formed, the switch terminal plate piece ST and the pin header base 48 installed with the first switch 41 to the third switch 43 being formed, and the motor terminal plate piece MT to which the electric motor 46 is connected being installed to the bosses BS1 and BS2, one pin header PHD having high accuracy of position and high accuracy of dimension can be configured. Thus, productivity of the door lock apparatus for vehicle 1 can be improved.

Furthermore, in implementation of this disclosure, it is not limited to the above-described embodiment, but various kinds of modifications are possible without departing from the object of this disclosure.

In the above-described embodiment, the flange portions 45b and 48b are provided with circular through holes TH_{45b} and TH_{48b}, and the columnar (or conically-shaped) boss BS1 is passed through the through holes TH_{45b} and TH_{48b} and fitted therein. Alternatively, the flange portions 45b and 48b may be provided with rectangular (or polygonal) through holes TH_{45b} and TH_{48b}, and a prismatic (or a pillar shape with a cross section being polygonal) boss BS1 may be inserted into the through holes TH_{45b} and TH_{48b} and fitted therein. Further, a part of the peripheral portion of the flange portions 45b and 48b may be provided with notch portions in a predetermined shape (e.g., rectangular and triangle), and these notch portions may be engaged (or abut) with the boss BS1 which is common to both. Further, in the above-described embodiment, the pin header base 45 and the pin header base 48 engage two positioning member (bosses BS1 and BS2) which are common to both, and positions of the pin header base 45 and the pin header base 48 are determined. Alternatively, the pin header base 45 and the pin header base 48 may engage one positioning member which is common to both, and positions of the pin header base 45 and the pin header base 48 may be determined.

A door lock apparatus for vehicle includes a first electric circuit, a second electric circuit, and a positioning member. The first electric circuit includes a plurality of first electric conductive plates, each being an elongated electric conductive plate and formed with terminals connected to an electrical component. The first electric circuit also includes a first support member extending over the terminals of the plurality of first electric conductive plates, the first support member supporting the terminals of the plurality of first electric conductive plates. The second electric circuit includes a plurality of second electric conductive plates, each being an elongated electric conductive plate and formed with terminals connected to an electrical component. The second electric circuit also includes a second support member extending over the terminals of the plurality of second electric conductive plates, the second support member supporting the terminals of the plurality of second electric conductive plates. The positioning member is configured to determine positions of the first support member and the second support member, and is commonly used for the first support member and the second support member.

In the above-described door lock apparatus for vehicle, each of the first support member and the second support member may include a plate shape portion. The plate shape portion may include a through hole. The positioning member may be a columnar member. The positioning member may be passed through the through hole of the first support member and the through hole of the second support member.

In the above-described door lock apparatus for vehicle, in a state where the first support member and the second support member are engaged to the positioning member, the first support member and the second support member may form one connector member.

In the above-described door lock apparatus for vehicle, the first support member and the second support member may be integrated with the plurality of first electric conductive plates and the plurality of second electric conductive plates.

It is possible to provide a door lock apparatus for vehicle which can improve productivity of the door lock apparatus for vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door lock apparatus for vehicle comprising:
a first electric circuit including a plurality of first electric conductive plates, each being an elongated electric conductive plate and formed with terminals connected to an electrical component, and a first support member extending over the terminals of the plurality of first electric conductive plates, and supporting the terminals of the plurality of first electric conductive plates;
a second electric circuit including a plurality of second electric conductive plates, each being an elongated electric conductive plate and formed with terminals connected to an electrical component, and a second support member extending over the terminals of the plurality of second electric conductive plates, and supporting the terminals of the plurality of second electric conductive plates; and
a positioning member configured to determine positions of the first support member and the second support member, and to be commonly used for the first support member and the second support member.

2. The door lock apparatus for vehicle according to claim 1, wherein
each of the first support member and the second support member includes a plate shape portion, the plate shape portion includes a through hole,
the positioning member is a columnar member, and
the positioning member is passed through a through hole of the first support member and a through hole of the second support member.

3. The door lock apparatus for vehicle according to claim 1, wherein,
in a state where the first support member and the second support member are engaged to the positioning member, the first support member and the second support member forms one connector member.

4. The door lock apparatus for vehicle according to claim 2, wherein,
in a state where the first support member and the second support member are engaged to the positioning member, the first support member and the second support member forms one connector member.

5. The door lock apparatus for vehicle according to claim 1, wherein
the first support member and the second support member are integrated with the plurality of first electric conductive plates and the plurality of second electric conductive plates.

6. The door lock apparatus for vehicle according to claim 2, wherein
the first support member and the second support member are integrated with the plurality of first electric conductive plates and the plurality of second electric conductive plates.

7. The door lock apparatus for vehicle according to claim 3, wherein
the first support member and the second support member are integrated with the plurality of first electric conductive plates and the plurality of second electric conductive plates.

8. The door lock apparatus for vehicle according to claim 4, wherein
the first support member and the second support member are integrated with the plurality of first electric conductive plates and the plurality of second electric conductive plates.
